(19) United States
(12) Patent Application Publication
(10) Pub. No.: US 2026/0296212 A1
(43) Pub. Date: Oct. 1, 2026

(54) VEHICLE ON-BOARD POWER CONVERSION DEVICE

(71) Applicant: KABUSHIKI KAISHA TOYOTA JIDOSHOKKI, Kariya-shi (JP)

(72) Inventors: Atsushi OSHIMA, Kariya-shi (JP); Katsuya USAMI, Kariya-shi (JP); Shunsuke AMBO, Kariya-shi (JP)

(73) Assignee: KABUSHIKI KAISHA TOYOTA JIDOSHOKKI, Kariya-shi (JP)

(21) Appl. No.: 19/571,714

(22) Filed: Mar. 19, 2026

(30) Foreign Application Priority Data
Mar. 26, 2025 (JP) 2025-052072

(51) Int. Cl. B60L 15/00; B60L 3/00

(52) U.S. Cl. CPC B60L 15/007; B60L 3/003; B60L 2210/40

(57) ABSTRACT

A vehicle on-board power conversion device includes an inverter configured to drive an electric motor by converting DC power supplied from a DC power supply into AC power and outputting the AC power, an LC low-pass filter connected to the inverter and configured to attenuate common-mode noise in a specified frequency band, and a housing accommodating the inverter and the LC low-pass filter. A resonance frequency of the LC low-pass filter is set to a frequency higher than a first frequency that is an integer multiple of a carrier frequency of the inverter and lower than a second frequency that is different from the first frequency and is an integer multiple of the carrier frequency. The second frequency is set to a frequency lower than the specified frequency band.

### CROSS-REFERENCE TO RELATED APPLICATIONS

This application is based upon and claims the benefit of priority from Japanese Patent Application No. 2025-025072, filed on Mar. 26, 2025, the entire contents of which are incorporated herein by reference.

### BACKGROUND

### 1. Field

The present disclosure relates to a vehicle on-board power conversion device.

### 2. Description of Related Art

JP2023-137684A discloses a motor-driven compressor that includes an inverter and an LC filter. The inverter includes switching elements. The LC filter attenuates common-mode noise generated by switching operations of the switching elements. The LC filter includes a common-mode choke coil and Y-capacitors. The common-mode noise has a frequency that is an integer multiple of the carrier frequency of the inverter.

In the LC filter, gain exceeds 0 dB in a frequency band including a resonance frequency. When the gain is greater than 0 dB, common-mode noise is amplified. Accordingly, in the LC filter, the resonance frequency is set to a frequency lower than the carrier frequency so as to prevent amplification of common-mode noise. To set the resonance frequency lower than the carrier frequency, it is necessary to increase at least one of the inductance of the common-mode choke coil and the capacitance of the Y-capacitors. This increases the size of the LC filter. If the Y-capacitors are increased in size, the impedance of the Y-capacitors decreases, which may increase a likelihood that current flows from the Y-capacitors to the housing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle on-board power conversion device includes an inverter configured to drive an electric motor by converting DC power supplied from a DC power supply into AC power and outputting the AC power, an LC low-pass filter connected to the inverter and configured to attenuate common-mode noise in a specified frequency band, and a housing accommodating the inverter and the LC low-pass filter. A resonance frequency of the LC low-pass filter is set to a frequency higher than a first frequency that is an integer multiple of a carrier frequency of the inverter and lower than a second frequency that is different from the first frequency and is an integer multiple of the carrier frequency. The second frequency is set to a frequency lower than the specified frequency band.

Other features and aspects will be apparent from the following detailed description, the drawings, and the claims.

### BRIEF DESCRIPTION OF THE DRAWINGS

FIG. 1 is a circuit diagram of a motor-driven compressor.

FIG. 2 is a graph showing frequency characteristics of an LC low-pass filter included in the motor-driven compressor shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle on-board power conversion device according to an embodiment will now be described.

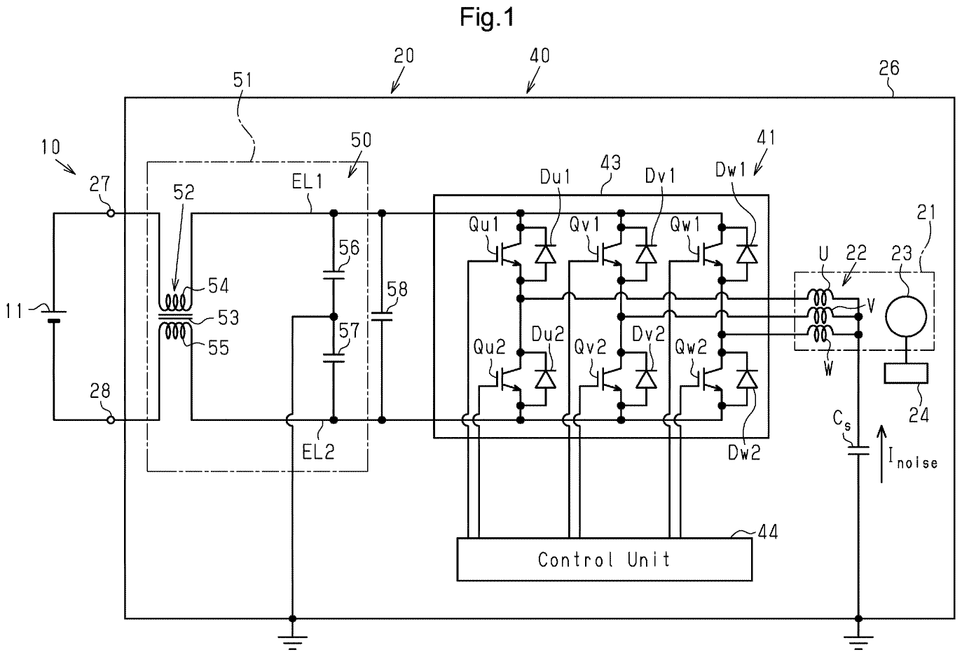

As shown in FIG. 1, a vehicle 10 includes a DC power supply 11 and a motor-driven compressor 20. The DC power supply 11 is, for example, a rechargeable battery or a power supply circuit.

The motor-driven compressor 20 includes an electric motor 21. The electric motor 21 is a three-phase motor that is driven by AC power. The electric motor 21 includes a stator 22 and a rotor 23. The stator 22 includes, for example, three coils U, V, and W connected in a star connection. When current flows through the coils U, V, and W, the rotor 23 rotates. The motor-driven compressor 20 includes a compression unit 24. The compression unit 24 is driven by the electric motor 21. For example, the compression unit 24 is driven by rotational force of the rotor 23. The compression unit 24 compresses and discharges fluid. The type of the compression unit 24 is, for example, a scroll type, a piston type, or a vane type.

The motor-driven compressor 20 includes a first input terminal 27 and a second input terminal 28. The first input terminal 27 is connected to a positive electrode of the DC power supply 11. The second input terminal 28 is connected to a negative electrode of the DC power supply 11.

### Vehicle On-Board Power Conversion Device

The motor-driven compressor 20 includes a vehicle on-board power conversion device 40. The vehicle on-board power conversion device 40 is provided between the DC power supply 11 and the electric motor 21. The vehicle on-board power conversion device 40 includes a first connection line EL1 and a second connection line EL2. The first connection line EL1 is connected to the first input terminal 27. The second connection line EL2 is connected to the second input terminal 28.

The vehicle on-board power conversion device 40 includes a housing 26. The housing 26 is made of metal.

The vehicle on-board power conversion device 40 includes an inverter 41. The inverter 41 is accommodated in the housing 26. The inverter 41 drives the electric motor 21 by converting DC power supplied from the DC power supply 11 into AC power and outputting the AC power.

The inverter 41 includes an inverter circuit 43 and a control unit 44. The inverter circuit 43 includes six switching elements Qu1, Qu2, Qv1, Qv2, Qw1, Qw2, and six diodes Du1, Du2, Dv1, Dv2, Dw1, Dw2. The switching elements Qu1 to Qw2 are, for example, insulated gate bipolar transistors (IGBTs). The diode Du1 is connected in parallel to the switching element Qu1. The diode Du2 is connected in parallel to the switching element Qu2. The diode Dv1 is connected in parallel to the switching element Qv1. The diode Dv2 is connected in parallel to the switching element Qv2. The diode Dw1 is connected in parallel to the switching element Qw1. The diode Dw2 is connected in parallel to the switching element Qw2. The switching elements Qu1 to Qw2 may be metal-oxide semiconductor field-effect transistors (MOSFETs). In this case, the diodes Du1 to Dw2 are parasitic diodes.

The switching elements Qu1 and Qu2 are connected in series to each other between the two connection lines EL1 and EL2. The switching elements Qv1 and Qv2 are connected in series to each other between the two connection lines EL1 and EL2. The switching elements Qw1 and Qw2 are connected in series to each other between the two connection lines EL1 and EL2.

A connection point between the switching element Qu1 and the switching element Qu2 is connected to the coil U. A connection point between the switching element Qv1 and the switching element Qv2 is connected to the coil V. A connection point between the switching element Qw1 and the switching element Qw2 is connected to the coil W.

The control unit 44 includes, for example, a processor and a storage unit. The processor may include, for example, a central processing unit (CPU), a graphics processing unit (GPU), or a digital signal processor (DSP). The storage unit may include random access memory (RAM) and read-only memory (ROM). The storage unit stores program codes or instructions configured to cause the processor to execute processes. The storage unit, which is a computer-readable medium, includes any type of medium that is accessible by a general-purpose computer or a dedicated computer. The control unit 44 may also be implemented by a hardware circuit such as an application specific integrated circuit (ASIC) or a field programmable gate array (FPGA). The control unit 44, which acts as processing circuitry, may include one or more processors that run on computer programs, one or more hardware circuits such as an ASIC and an FPGA, or a combination of such devices.

The control unit 44 controls the switching elements Qu1 to Qw2. The control unit 44 generates voltage commands of the U-phase, the V-phase, and the W-phase, and generates a PWM signal by comparing the voltage commands with a carrier wave. The control unit 44 switches on and off the switching elements Qu1 to Qw2 by the PWM signal.

The vehicle on-board power conversion device 40 includes a noise reducing unit 50. The noise reducing unit 50 is provided between the DC power supply 11 and the inverter 41. The noise reducing unit 50 reduces common-mode noise and normal-mode noise.

The noise reducing unit 50 includes an LC low-pass filter 51 and an X-capacitor 58. The LC low-pass filter 51 is accommodated in the housing 26. The LC low-pass filter 51 includes a common-mode choke coil 52 and two Y-capacitors 56, 57. The common-mode choke coil 52 includes a core 53, a first winding 54, and a second winding 55. The first winding 54 and the second winding 55 are wound around the core 53. The first winding 54 is provided on the first connection line EL1. The second winding 55 is provided on the second connection line EL2.

The two Y-capacitors 56, 57 are connected in series to each other between the first connection line EL1 and the second connection line EL2. The Y-capacitors 56, 57 are also referred to as line bypass capacitors. Each of the two Y-capacitors 56, 57 may be formed by connecting multiple capacitors together. The connecting point between the two Y-capacitors 56, 57 is grounded to the body of the vehicle 10 via the housing 26.

The X-capacitor 58 is provided in parallel with the series connection of the two Y-capacitors 56, 57. The X-capacitor 58 is also referred to as an across-the-line capacitor. The X-capacitor 58 may be formed by connecting multiple capacitors together.

The LC low-pass filter 51 is a low-pass filter including the common-mode choke coil 52 and the Y-capacitors 56, 57. The resonance frequency f₀ of the LC low-pass filter 51 is expressed by the following Equation (1).

$$\begin{matrix}[ Equation 1 ] & \\ {f}_{0} = \frac{1}{2 π \sqrt{L \times C}} & ( 1 )\end{matrix}$$

Lis the common-mode inductance [H] of the common-mode choke coil 52. C is the combined capacitance [F] of the two Y-capacitors 56, 57. The resonance frequency f₀ of the LC low-pass filter 51 is set to a frequency higher than a first frequency and lower than a second frequency. The first frequency is an integer multiple of a carrier frequency f₁ of the inverter 41. The second frequency is an integer multiple of the carrier frequency f₁ of the inverter 41 and is different from the first frequency. The second frequency is higher than the first frequency. The carrier frequency f₁ of the inverter 41 is the frequency of the carrier wave. The carrier frequency f₁ is, for example, 20 KHz.

In the present embodiment, the first and second frequencies are odd multiples of the carrier frequency f₁. Specifically, the first frequency is equal to the carrier frequency f₁, that is, the carrier frequency f₁ itself. The second frequency is a third-order frequency f₃ that is three times the carrier frequency f₁. Accordingly, the resonance frequency f₀ is set to a frequency higher than the carrier frequency f₁ and lower than the third-order frequency f₃.

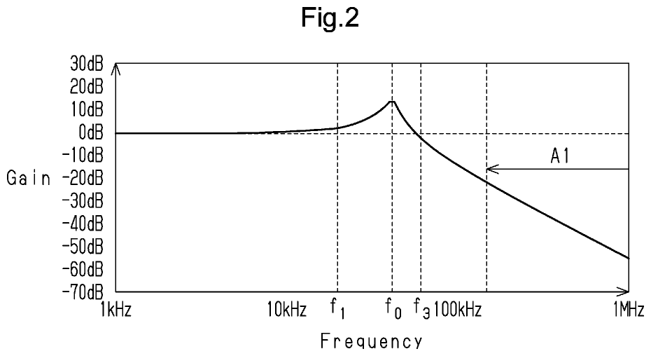

As shown in FIG. 2, the LC low-pass filter 51 is configured to attenuate common-mode noise in a specified frequency band A1. For example, the LC low-pass filter 51 is configured to reduce common-mode noise in the frequency band A1 specified by a standard to below a reference value. The standard is, for example, ECE Regulation No. 10: Uniform provisions concerning the approval of vehicles with regard to electromagnetic compatibility.

In the present embodiment, the LC low-pass filter 51 is configured to reduce common-mode noise in the frequency band A1 of 150 kHz or higher to below the reference value. The second frequency is set to a frequency lower than the specified frequency band A1. When the LC low-pass filter 51 is configured to reduce common-mode noise in the frequency band A1 of 150 kHz or higher to below the reference value, the second frequency is lower than 150 kHz.

When the gain is greater than 0 dB, common-mode noise is amplified. When the gain is less than 0 dB, common-mode noise is attenuated. The second frequency is a frequency at which common-mode noise is attenuated. That is, the second frequency is a frequency at which the gain becomes less than 0 dB.

The common-mode noise reduced by the LC low-pass filter 51 includes a common-mode current Iₙₒᵢₛₑ. The common-mode current Iₙₒᵢₛₑ is generated due to a stray capacitance Cs generated between the electric motor 21 and the housing 26. The common-mode current Iₙₒᵢₛₑ is generated by switching operations of the switching elements Qu1 to Qw2. The LC low-pass filter 51 prevents, by reducing the common-mode current Iₙₒᵢₛₑ, the common-mode current Iₙₒᵢₛₑ from flowing out to the exterior of the motor-driven compressor 20.

### Operation of the Present Embodiment

When switching operations of the switching elements Qu1 to Qw2 are performed to drive the electric motor 21, common-mode noise is generated. The common-mode noise includes noise components having frequencies that are integer multiples of the carrier frequency f₁.

As shown in FIG. 2, in the LC low-pass filter 51, the gain is greater than 0 dB in a band including the resonance frequency f₀. When the gain is greater than 0 dB, common-mode noise is amplified. When the gain is less than 0 dB, common-mode noise is attenuated.

In the LC low-pass filter 51, common-mode noise is amplified in a band including the resonance frequency f₀. The amplification factor of the common-mode noise peaks at the resonance frequency f₀ and decreases as the frequency deviates from the resonance frequency f₀. In a frequency band in which the gain is less than 0 dB, the attenuation factor increases as the frequency increases above the resonance frequency f₀.

In general, the resonance frequency f₀ is set to a frequency lower than the carrier frequency f₁. This is because common-mode noise generated by switching has frequencies that are integer multiples of the carrier frequency f₁, and therefore, by setting the resonance frequency f₀ to a frequency lower than the carrier frequency f₁, amplification of the common-mode noise is suppressed. In addition, lowering the resonance frequency f₀ increases the attenuation factor in the specified frequency band A1.

As can be understood from Equation (1), in order to lower the resonance frequency f₀, it is necessary to increase at least one of the common-mode inductance L of the common-mode choke coil 52 or the combined capacitance C of the Y-capacitors 56, 57. In this case, the size of at least one of the common-mode choke coil 52 and the Y-capacitors 56, 57 is increased; that is, the LC low-pass filter 51 is increased in size.

In the present embodiment, the resonance frequency f₀ of the LC low-pass filter 51 is set to a frequency higher than the first frequency and lower than the second frequency. As a result, common-mode noise in a specific frequency band may be amplified.

For example, in the example shown in FIG. 2, common-mode noise at the carrier frequency f₁ may be amplified. However, because the carrier frequency f₁ is not a frequency at which attenuation is required by a standard, a slight amplification is permissible. Further, by not causing the carrier frequency f₁ to coincide with the resonance frequency f₀, the amplification factor of the common-mode noise at the carrier frequency f₁ is prevented from being excessive.

In addition, the common-mode noise having a frequency that is an odd multiple of the carrier frequency f₁ is greater than the common-mode noise having a frequency that is an even multiple of the carrier frequency f₁. For example, when the duty cycle of the switching elements Qu1 to Qw2 is 50%, common-mode noise having a frequency that is twice the carrier frequency f₁ is not generated. Even when the duty cycle is a value different from 50%, common-mode noise having a frequency that is an even multiple of the carrier frequency f₁ is lower than common-mode noise having a frequency that is an odd multiple of the carrier frequency f₁. Accordingly, in the example shown in FIG. 2, although common-mode noise having a frequency that is twice the carrier frequency f₁ may be amplified, the common-mode noise at that frequency is itself small, and therefore no practical problem arises.

### Advantages of the Present Embodiment

(1) The resonance frequency f₀ of the LC low-pass filter 51 is higher than the first frequency, which is an integer multiple of the carrier frequency f₁ of the inverter 41, and lower than the second frequency, which is different from the first frequency and is an integer multiple of the carrier frequency f₁. The resonance frequency f₀ of the LC low-pass filter 51 can be increased as compared with a case in which the resonance frequency f₀ of the LC low-pass filter 51 is set to a frequency lower than the carrier frequency f₁. This prevents the LC low-pass filter 51 from being increased in size.

(2) In the vehicle 10, leakage current from the motor-driven compressor 20 is detected. If the combined capacitance C of the Y-capacitors 56, 57 is increased in order to lower the resonance frequency f₀ of the LC low-pass filter 51, the impedance of the Y-capacitors 56, 57 decreases. As a result, current flows from the Y-capacitors 56, 57 to the housing 26, which may cause leakage current to be erroneously detected in the vehicle 10. In the embodiment, because the resonance frequency f₀ of the LC low-pass filter 51 can be increased, an increase in the combined capacitance C of the Y-capacitors 56, 57 can be suppressed. Accordingly, erroneous detection of leakage current caused by a reduction in impedance of the Y-capacitors 56, 57 is suppressed.

(3) The first and second frequencies are odd multiples of the carrier frequency f₁. The resonance frequency f₀ is therefore prevented from coinciding with a frequency that is an odd multiple of the carrier frequency f₁. The common-mode noise having a frequency that is an odd multiple of the carrier frequency f₁ is greater than the common-mode noise having a frequency that is an even multiple of the carrier frequency f₁. Therefore, by preventing the resonance frequency f₀ from coinciding with a frequency that is an odd multiple of the carrier frequency f₁, it is possible to prevent the common-mode noise having a frequency that is an odd multiple of the carrier frequency f₁ from being excessively amplified.

(4) The first frequency is the carrier frequency f₁. The second frequency is a third-order frequency f₃ that is three times the carrier frequency f₁. Thus, it is possible to increase the difference between the resonance frequency f₀ and the specified frequency band A1 while preventing the resonance frequency f₀ from coinciding with a frequency that is an odd multiple of the carrier frequency f₁. The attenuation factor of common-mode noise increases with increasing frequency above the resonance frequency f₀. Accordingly, the attenuation factor of the specified frequency band A1 is increased.

### Modifications

The above-described embodiment may be modified as follows. The above-described embodiment and the following modifications can be combined if the combined modifications remain technically consistent with each other.

The resonance frequency f₀ of the LC low-pass filter 51 may be changed as long as it is set to a frequency higher than the first frequency and lower than the second frequency. The range of permissible values for the resonance frequency f₀ of the LC low-pass filter 51 varies depending on the value of the carrier frequency f₁ and the value of the specified frequency band A1. Accordingly, the resonance frequency f₀ of the LC low-pass filter 51 may be set such that a required degree of attenuation factor of common-mode noise in the specified frequency band A1 is ensured while the size of the LC low-pass filter 51 remains within an allowable range.

For example, the resonance frequency f₀ of the LC low-pass filter 51 may be set to a frequency higher than a third-order frequency f₃ that is three times the carrier frequency f₁ and lower than a fifth-order frequency f₅ that is five times the carrier frequency f₁. Alternatively, the resonance frequency f₀ of the LC low-pass filter 51 may be set to a frequency higher than a first frequency that is an even multiple of the carrier frequency f₁ and lower than a second frequency that is an even multiple of the carrier frequency f₁.

The vehicle on-board power conversion device 40 may be mounted in a vehicle on-board device different from the motor-driven compressor 20.

### Definitions

The expression “at least one” as used herein means “one or more” of desired options. In one example, the phrase “at least one of” as used in this disclosure means “only one single choice” or “both of two choices” if the number of its choices is two. As another example, the expression “at least one” used herein means “only one option” or “a combination of any two or more options” if the number of options is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle on-board power conversion device, comprising:
an inverter configured to drive an electric motor by converting DC power supplied from a DC power supply into AC power and outputting the AC power;
an LC low-pass filter connected to the inverter and configured to attenuate common-mode noise in a specified frequency band; and
a housing accommodating the inverter and the LC low-pass filter, wherein
a resonance frequency of the LC low-pass filter is set to a frequency higher than a first frequency that is an integer multiple of a carrier frequency of the inverter and lower than a second frequency that is different from the first frequency and is an integer multiple of the carrier frequency, and
the second frequency is set to a frequency lower than the specified frequency band.

2. The vehicle on-board power conversion device according to claim 1, wherein
the first frequency is an odd multiple of the carrier frequency,
the second frequency is an odd multiple of the carrier frequency, and
a component of the common-mode noise having a frequency that is an odd multiple of the carrier frequency is greater than a component of the common-mode noise having a frequency that is an even multiple of the carrier frequency.

3. The vehicle on-board power conversion device according to claim 2, wherein
the first frequency is equal to the carrier frequency,
the second frequency is three times the carrier frequency, and
the second frequency is a frequency that attenuates the common-mode noise.

4. The vehicle on-board power conversion device according to claim 2, wherein
the first frequency is three times the carrier frequency, and
the second frequency is five times the carrier frequency.
